(19) United States
(12) Patent Application Publication
(10) Pub. No.: US 2012/0025972 A1
(43) Pub. Date: Feb. 2, 2012

(54) TEMPERATURE ALARM SYSTEM OUTLET MODULE

(76) Inventor: David Boyden, Chicago, IL (US)

(21) Appl. No.: 13/195,606

(22) Filed: Aug. 1, 2011

Related U.S. Application Data
(60) Provisional application No. 61/369,957, filed on Aug. 2, 2010.

(51) Int. Cl. G08B 17/06

(52) U.S. Cl. 340/539.1

(57) ABSTRACT

A portable alarm outlet module is pluggable into a conventional wall outlet. The alarm module contains circuitry which monitors the outlet and detects fire-causing conditions at, or in the proximity of the outlet. The alarm module may contain a transmitter circuit for transmitting RF signals or alternatively a transceiver circuit that can transmit and receive RF signals that contain information developed by the monitoring circuit. The RF signals are sent to a main control unit where display information is viewed by an end user. The transceiver alarm module is capable of communicating with other transceiver alarm modules in a daisy chain effect to monitor working condition of alarm modules.

### RELATED APPLICATIONS

### Federally Sponsored Research or Development

This application makes reference to, claims priority to and claims benefit from U.S. Provisional Patent Application Ser. No. 61/369,957, entitled “Temperature Alarm System Module” and filed on Aug. 2, 2010.

### MICROFICHE/COPYRIGHT REFERENCE

[Not Applicable]

### BACKGROUND OF THE INVENTION

The invention relates to protection against fires caused by electrical problems, and more particularly, to a system and individual components designed to provide an alert of a potential or actual fire caused by faulty electrical wiring.

Electrical fires can be caused by faulty wiring that causes an electrical short. Electrical current flows in a circuit like water in a stream. When a large boulder is placed in a stream, the water may overflow onto the bank because it has nowhere else to go. A similar phenomena occurs with current flowing through wires. When too much current is flowing at once, the excess current has nowhere to go. If a circuit breaker does not behave properly to cut off the current flow, the wires begin to heat up. Like the water overflowing onto the banks, the excess current can “overflow,” and an electrical fire may result. Thus, a short circuit may start a heating process in a wire, and the increasing heat may eventually lead to a fire.

These electrical fires have been a problem since the invention of electricity, and over ninety-four thousand electrical fires occur each year in the United States alone. An electrical fire is serious because the fire can start behind a wall and spread through much of a building before being detected. In fact, electrical shorts have been known to burn for eight hours before they fully ignite.

As more and more electrical devices are used, more electricity is demanded from a single outlet. Additionally, controlling current at a circuit breaker becomes harder, and circuit breaker failure becomes more common. Moreover, electrical fire hazards still exist in many homes and buildings. For example, aluminum wiring was banned in many states when it was discovered to be a major cause of electrical fires. However, aluminum wiring is not banned in some states.

### BRIEF SUMMARY OF THE INVENTION

The early warning fire detection system of the present invention detects problems at electrical outlets, wall lights and switches, outlet cords, electrical wires and other electrical devices, where the problems may indicate potential fire-causing conditions. Information regarding each of several areas may be centrally received and displayed to an end user.

In some embodiments, a portable transmitter box is pluggable into a conventional wall outlet. The transmitter box may contain circuitry which can monitor the outlet in close proximity and detect fire-causing conditions at the outlet. Also, the transmitter box may contain a transmitter circuit for transmitting RF signals containing information developed by the monitoring circuit, and the transmitter box may send signals to a main control unit. The main control unit may have a signal receiver that receives RF signals from the transmitter box, and the main control unit may display information regarding the transmitter box to an end user.

In some embodiments, a portable alarm box pluggable into a conventional wall outlet may contain circuitry which can monitor another outlet in close proximity and detect fire-causing conditions at that outlet. Also, the alarm box may contain a transceiver circuit for transmitting RF signals containing information developed by the monitoring circuit, and the alarm box may send signals to a main control unit. The alarm box with a transceiver may also be capable of receiving signals from the main control unit, other wireless devices or other alarm boxes. The main control unit may have a signal receiver that receives RF signals from the transmitter box, and the main control unit may display information regarding the transmitter box to an end user.

In another embodiment, a plurality of transmitter boxes is present, and the transmitter boxes are pluggable into several outlets throughout a building, or in moderate proximity to each other. In this case, the main control unit may receive status information from each of the transmitter boxes.

In another embodiment, a plurality of alarm boxes with transceivers may be pluggable into several outlets throughout the building. The transceiver equipped alarm boxes may communicate with each other, with the main control unit or other wireless devices to communicate the status of individual transceiver equipped alarm boxes.

There are some electrical fire protection or alarm systems that are available, but none of these systems is effective at the early detection heat due to faulty wiring. These prior systems fail to turn off excess current building in the wire. One of the advantages of this system is the effective detection of electrical shorts, thus providing early detection of potential fire-causing conditions. Another advantage of this system is to prevent a conductor from exceeding its normal temperature rating.

### BRIEF DESCRIPTION OF SEVERAL VIEWS OF THE DRAWINGS

FIG. 1 is a view of an embodiment of an early warning fire detection system.

FIG. 2 is a perspective view of an alarm module transmitter box of FIG. 1 that is pluggable into a conventional wall outlet.

FIG. 3 is block diagram of circuitry inside the alarm module transmitter box of FIG. 2.

FIGS. 4-10 are diagrammatic views of display screens for display at the main control unit of FIG. 1

FIG. 11 is schematic diagram of a circuitry embodiment of the alarm module transmitter box of FIG. 1.

FIG. 12 is schematic diagram of a circuitry embodiment of the main control unit of FIG. 1.

FIG. 13 is a block diagram of another embodiment an alarm module circuitry containing a transceiver.

FIG. 14 is illustrates another embodiment of a wire tie containing thermistors and a transmitter.

### DETAILED DESCRIPTION OF THE INVENTION

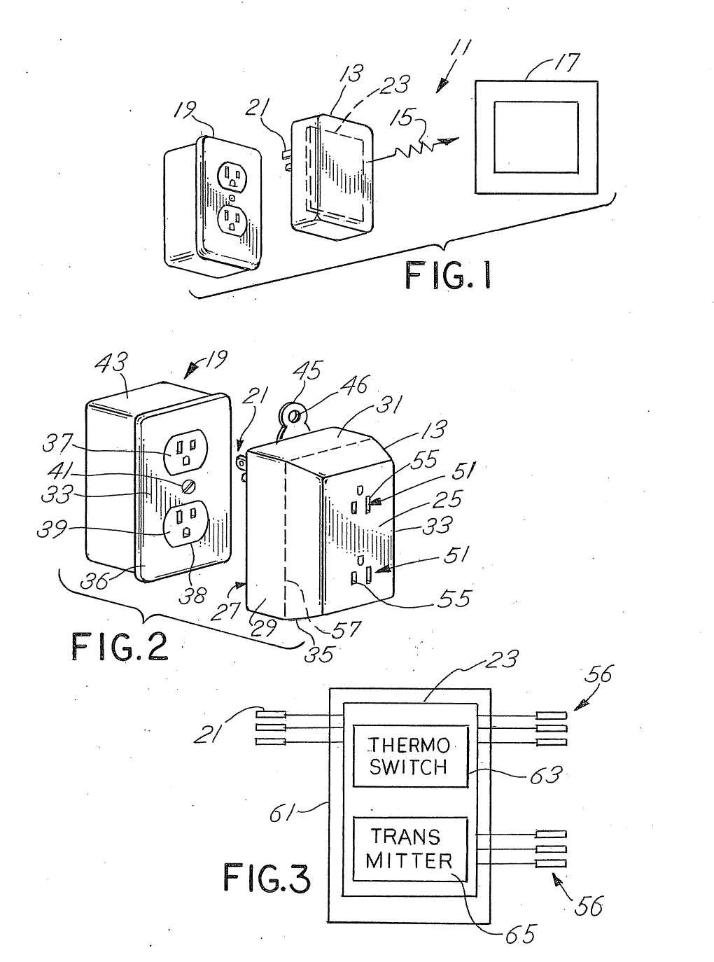

Referring to FIG. 1, an early warning fire detection system 11 includes a transmitter box 13 which transmits information signals 15 to a master main control unit 17. In one example, transmitter box 13 may be pluggable into a conventional electrical wall outlet 19, where the wall outlet could provide 120 volts, 240 volts, 380 volts, or other voltage configurations. The wall outlet could be located, for example, in a residential or commercial building. While only one transmitter box 13 is shown in FIG. 1, a plurality of boxes 13 may be connected within system 11, with each box 13 plugged into a different electrical wall outlet 19 of the building.

In other examples, transmitter box 13 can be connected to a building's power supply through a way other than a conventional electrical wall outlet. For example, transmitter box 13 can be screwed or plugged into a lamp or wall light. Alternatively, transmitter box 13 can be plugged into an outlet strip or surge protector. Alternatively, the transmitter box may be wired into any lam, electric stove, microwave oven power supply electric motor, circuit breaker panel or the like

In other examples, transmitter box 13 can be placed semi-permanently, in a non-pluggable fashion, at a location where it can monitor wiring of a building. For example, transmitter box 13 could be embedded inside a wall, positioned in close proximity to wiring in the wall, so it could monitor the wiring in the wall. In these examples, it may be the case that inner monitoring circuitry of transmitter box 13 alone, without the outer casing of the transmitter box, is placed semi-permanently at a location.

Master main control unit 17 is typically secured to a wall within the building, for example, a central hallway, in order to provide a visual display to the system user based on information signals 15. Information signals 15 are transmitted as RF signals which provide temperature information, and other information, to main control unit 17.

Transmitter box 13 includes three conventional outlet prongs 21 which plug into a conventional wall outlet, for example, outlet 19, in a conventional manner. The wall outlet could provide 120 volts, 240 volts, 380 volts, or other voltage configurations. Transmitter box 13 is formed of a hollow box-shaped structure, made from plastic, for example, and houses an electrical circuit 23 within box 13.

As shown in FIG. 2, transmitter box 13 is rectangular in shape having six sides: a front side 25, a back-side 27 and four lateral sides 29, 31, 33 and 35. Back side 27 is planar for meeting against the outer surface 33 of a conventional wall outlet plate 36. Outlet plate 36 is screwed down tightly against the metal housing 43 of wall outlet 19. The pair of outlets 37, 39 of wall outlet 19 protrudes through apertures 38 formed in plate 36, in a conventional fashion. A screw 41 is centrally located to hold plate 36 tightly against, or with respect to, metal housing 43 of wall outlet 19.

Back side 27 of transmitter box 13 may include a securement tab 45 which is used to secure transmitter box 13 in its plugged-in position, plugged into the lower outlet 39. Tab 45 has a flat or planar front and back portion, and provides a circular opening 46 for receiving screw 41 in order to secure transmitter box 13 to wall outlet 19. Use of securement tab 45 is optional, and other types of securement may be used, if desired

Front side 25 of transmitter box 13 is rectangular in shape and may be of a size similar to conventional wall plate 36. A pair of prong receptacles 51 are located in front side 25 of box 13, in a center location similar to that of conventional wall plate 36. Each receptacle 51 has three conventionally shaped, prong-receiving apertures 55. Thus, the appearance of front side 25 provides box 13 with the appearance of a conventional wall outlet, so as to invite a user to insert an electrical plug.

Each receptacle 51 may receive a conventional three prong electrical plug for connection of the plug with wall outlet 19. As will suggest itself, receptacle 51 may include only one or two prong receiving apertures 55 so as to receive a correspondingly shaped electrical plug. Instead of two prong receptacles 51, one, or more than two, may be provided, as will suggest itself.

Transmitter box 13 may be formed of two halves separable along line 57, shown in FIG. 2 as a dashed line. Separation of the two parts of box 13 allows access to circuit 23, as well as facilitates the original positioning of circuit 23 within transmitter box 13. The two halves may be secured together by tape, glue, epoxy or the like. Alternatively, the two halves may be secured together by a plurality of screws. For example, four screws may be inserted into the back side 27 of the transmitter box, and the screws may extend, perpendicular to side 27, through the back half of transmitter box 13, and contact the front half of transmitter box 13, such that the two halves of transmitter box 13 are held tightly together.

Circuit 23 monitors high temperature conditions in box 13, and thus effectively monitors temperature conditions of wall outlet 19, in order to alert control unit 17 of an excessively high temperature. That is, the prongs 21 of box 13 act as a “thermometer” to measure the temperature of the outlet.

For example, potential excessive current draw from the outlet 19 may be indicative of a high temperature condition or a potential fire-causing problem. Also, the actual temperature of a piece of metal, or a metal component, within transmitter box 13 may be monitored. Such a metal piece, for example, a copper plate, may be purposely secured within box 13 and from which plate temperature may be judged.

Referring to FIG. 3, circuit 23 may be formed of a thermo switch circuit 63 and a transmitter 65 located on a circuit board 61 which is secured within the housing of transmitter box 13. Circuit board 61 is electrically connected to metal prongs 21 which mate with wall outlet 19. Circuit board 61 (or else prongs 21) is connected to metal receptacles 56 which are positioned in prong receiving apertures 55 of box 13 (FIG. 2). Metal receptacles 56 make electrical connection with the prongs of an electrical plug inserted in box 13 at receptacle 51.

Thermo switch circuit 63 is operable in order to disconnect electrical power passing from prongs 21 into metal receptacles 56. Thermo switch circuit 63 monitors the amount of electrical current passing through transmitter box 13 relative to a threshold value of current indicative of an electrical short. Upon the threshold being exceeded, thermo switch circuit 63 is opened. In response to the opening of thermo switch circuit 63, a RF signal 15 (FIG. 1) is generated by transmitter 65. RF signal 15 carries information that indicates that the thermo switch circuit 63 is open.

Thermo switch circuit 63 is used to detect excess heat signals produced by short circuits or overloads within the electrical system. Alternatively, thermo switch circuit 63 may be substituted with a thermistor circuit which creates a voltage reading which is proportional to the resistance of a thermistor, and which resistance varies with temperature at the thermistor. The thermistor circuit may be attached within transmitter box 13 in any convenient manner, so as to afford good thermal and ambient temperature measurement within box 13. For example, the thermistor circuit may be attached to a copper plate which is disposed in transmitter box 13 and which is insulated electrically.

Circuitry 23 may operate such that whenever the voltage output at the thermistor circuit exceeds a threshold voltage, a signal is produced. Whenever the signal is produced, it is inputted to transmitter 65. Transmitter 65 sends a signal to main control unit 17 indicating that a high temperature exists in the transmitter box 13. Transmitter 65 may additionally send an actual temperature value and a time stamp indicating the time of occurrence of the high temperature. Transmitter 65 may also send a unique number for identifying the transmitter box 13 from which the high temperature was sensed. Where each transmitter boxes 13 of the system has a different identifying number, main unit 17 may recognize the identity of the room where the particular transmitter box is located.

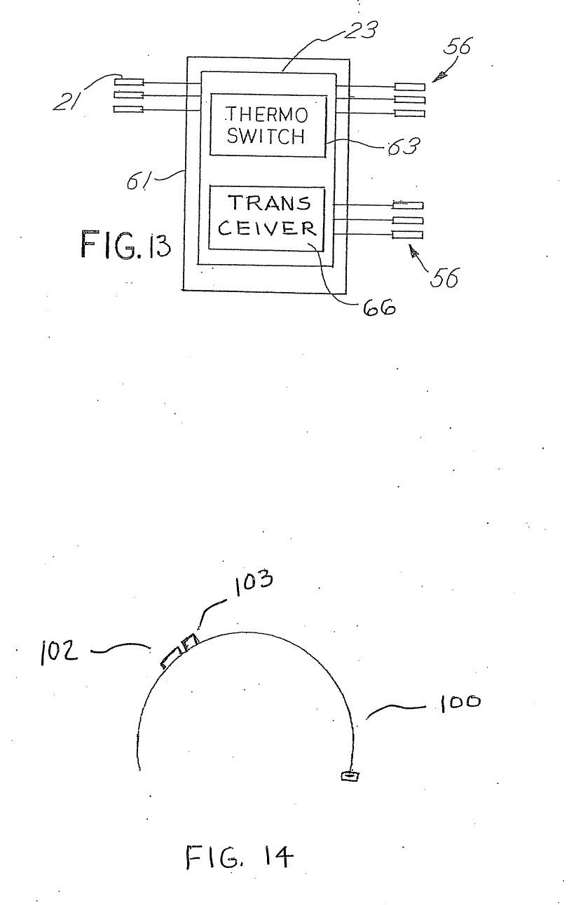

Referring to FIG. 13, alternatively, the transmitter 65 in circuit 23 may be replaced by a transceiver 66. The aforementioned transmitter box 13 thus becomes transceiver box 13. The transceiver box may be capable of receiving signals from main control unit 17, other transceivers or wireless devices. FIGS. 1 and 2 and numbers therein equally apply to the transceiver box.

Referring to FIG. 13, FIG. 1 and FIG. 2, circuit 23 may be formed of a thermo switch circuit 63 and a transceiver 66 located on a circuit board 61 which is secured within the housing of transceiver box 13. Circuit board 61 is electrically connected to metal prongs 21 which mate with wall outlet 19. Circuit board 61 (or else prongs 21) is connected to metal receptacles 56 which are positioned in prong receiving apertures 55 of box 13 (FIG. 2). Metal receptacles 56 make electrical connection with the prongs of an electrical plug inserted in box 13 at receptacle 51.

Thermo switch circuit 63 in transceiver box 13 operates in a similar fashion to thermo switch circuit 63 in transmitter box 13.

In the transceiver box, two thermistors are positioned in close proximity to metal prongs 21 for measuring the temperature at prongs 21. One thermistor is placed relative to the hot line and the other thermistor is placed relative to the neutral line. A third thermistor in the circuit is outside of the outlet module to measure the ambient temperature. The three measuring devices form a delta format. The delta format communicates with the transceiver 66 sending a signal to alarm module 17 or to other communicator panels designed to receive RF signals from the transceiver box when there are excessive temperatures detected by the thermistors. The Delta formation is connected to the microcontroller within the outlet module.

Transceiver box with transceiver 66 in circuit 23 may be plugged into any AC outlet and the transceivers may communicate with each other using a daisy chain effect. For example transceiver box in outlet #1 may communicate with transceiver box in outlet #2 asking the status of transceiver box in outlet #2. This communication may continue throughout the fire detection system. When one transceiver box fails to respond, an alarm may be sent to the main control unit indicating that the transceiver box that did not respond and thus may be not functioning properly.

It is contemplated that a transceiver box may not be required in every outlet. Because most new construction have outlets spaced every six feet, and the transceiver box thermistors are able to detect overheating of the electrical wire in a conduit over a six foot range, it becomes unnecessary to install transceiver boxes in every electrical outlet.

Alternative to plugging into an AC outlet, transceiver boxes may be wired into any lamp, electrical stove, microwave oven, TV power supply, laptop power supply, electric fan motor, circuit breaker panel and the like.

In another embodiment, the thermistors and transceivers may be enclosed in a surge suppressor. The thermistors and transceiver may be located outside the transceiver box or surge suppressor and attached directly to the electrical wiring to monitor the temperature of electrical wires in industrial, residential or commercial vehicles such as airplanes or boats. For example, the insulation may deteriorate or be worn away in a specific application such as an airplane's fuselage. The placing of the thermistors relative to the electrical wiring may detect any overheating in the wires.

Referring to FIG. 14. in an another embodiment, using nano technology, two thermistors and transmitter 102 may be reduced in size using nano-technology and enclosed within a wire tie 100. Wire tie 100 is used to tie electrical wiring together. One thermistor in wire tie 100 may measure the temperature of the bundle of wires the wire tie 100 is wrapped around. The other thermistor may measure the ambient temperature. A three-volt battery 103, such as a lithium battery, may be used to supply power to the temperature monitoring wire ties 100 The transmitter in wire tie 100 may communicate the information from the thermistors wirelessly to any standard alarm system. This embodiment may be used to monitor wiring in building, residential homes, aircraft fuselages, boating and other commercial vehicles.

In one example, referring to FIG. 1, when circuit 23 senses a problem at one of the outlets, it may send a RF signal to the master control unit 17 informing the master control unit that there is was a problem at the outlet and the transmitter box has responded to the problem, for example, by disconnected power at the outlet. In another example, when circuit 23 sense a problem, it may send a RF signal to the master control unit merely informing the master control unit that a problem exists, but the transmitter box has not disconnected the power or otherwise responded to the problem.

In addition, whenever the main control unit 17 receives information about a problem at one of the outlets, it may inform an end user. Thus, the end user could remedy the problem, for example, by physically inspecting the outlet, or by choosing from options that may permit the user to address the problem remotely. In one example, an RF signal alert may be sent from the main control unit 17 to the end user's computer via email or a software program. Thus, the user could be sitting at work or some other location away from home and receive an alert that there is a problem with one of the outlets at home.

In another example, an RF signal alert may be sent from the main control unit 17 to an end user's wireless device (such as an iPhone telephone, Blackberry device, or iPod device) to alert the user to a problem. The alert may be sent to the end user as a SMS text message, email, or other electronic message. Also, main control unit 17 may signal a calling station or some other security facility. Control unit 17 would only report to a calling station if it considers an electrical fire potential, for example, based on the amount of heat at the outlet.

In another example, after receiving an alert from the main control unit 17 or from the individual transceiver 66 in FIG. 13, the end user may send a signal back to the main controller unit 17 directing main controller 17 to send a signal to transceiver 66 directing circuit 23 to disconnect power at the specific outlet box from which an alarm was received. Further, the end user may direct the circuit 23 to disconnect power by sending a signal from the end user's wireless device directly to transceiver 66.

In another example, transmitter 65 or transceiver 66 may be designed to communicate with any smoke detector capable of receiving an RF signal to place smoke detector in an alarm mode if transmitter 65 or transceiver 66 send an alert signal to the smoke detector. A smoke detector equipped with a transceiver may communicate directly to transceiver 66 and disconnect outlet from system.

Also, when a transmitter box 13 detects a problem at one of the outlets, it may send a signal alert directly to some other communicator panel other than main control unit 17. This alert may be an alternative or a supplement to transmitter box 13 sending a signal alert to main control unit 17. The communicator panel could be designed to detect RF signals from the transmitter boxes. The communicator panel can be any device that alerts users to a problem at one of the outlets. For example, the communicator panel may generate noises such as rings, tones, beeps or other alarm sounds. The communicator panel may also be capable of sending RF signals to transceiver 66 or end user's wireless devices. The communicator panel may also receive signals from end user's wireless devices.

Additionally, when a transmitter or transceiver box 13 is initially plugged into a wall outlet 19, transmitter or transceiver box 13 may send initiation and identification information to master control unit 17. Transmitter or transceiver box 13 may determine its location and it may send location information to the master control unit 17. Transmitter or receiver box 13 may sense location information automatically or a user may enter location information into the transmitter box 13 via switches, buttons or the like. Master control unit 17 can then detect that a new transmitter box 13 has been plugged into a wall outlet. Master control unit 17 may determine the location of a new transmitter box 13 based on location information sent to the main control unit by transmitter box 13 or, alternatively, the user may enter or select location information at the time the main control unit detects the new transmitter box. Once the main control unit 17 receives location information for a new transmitter box, it stores information relating to the transmitter box corresponding to the particular location.

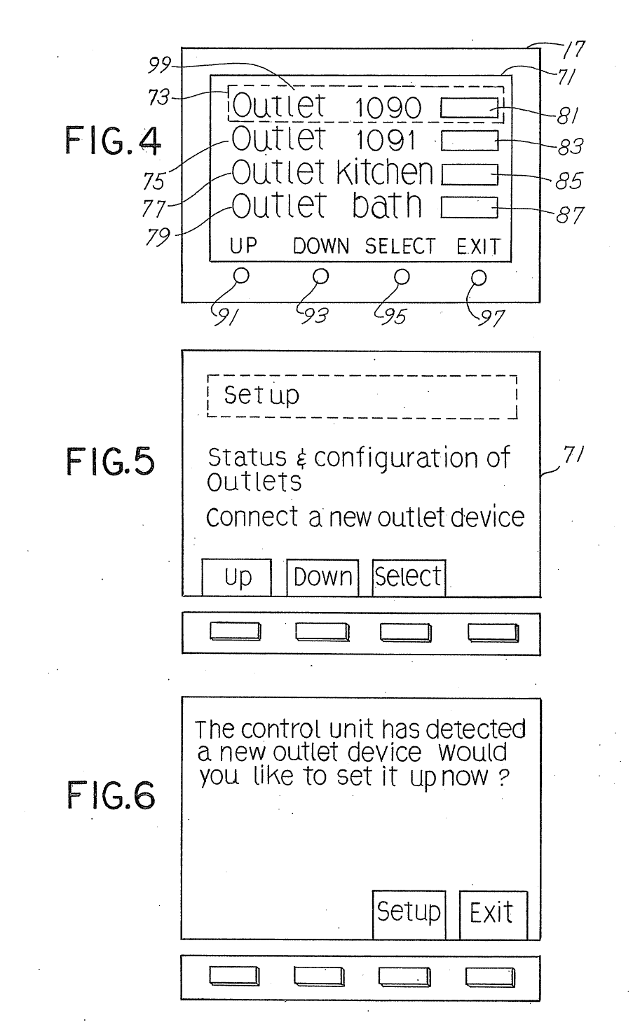

Referring to FIG. 4, master main control unit 17 includes an electronic display 71 for providing visual information to a user. Additionally, master control unit 17 includes a plurality of manually operable buttons, such as buttons 91, 93, 95, 97, that are located adjacent to the electronic display 71. The display 71 is capable of displaying indicia such as numbers, text and graphics. For example, a portion of the electronic display can display information to the user such as status updates, commands, or questions. In another example, a portion of the electronic display can display choices that the user can choose among, and a visual highlight 99 may indicate at least one choice that is currently selected. Additionally, a portion of the electronic display 71 may display a plurality of soft labels that correspond to the plurality of manually operable buttons. For example, each soft label may correspond to the closest manually operable button. These soft labels can change according to different functionalities that the buttons can perform, in order to provide the user with an accurate description of the current functionality of each button.

In another example, the manually operable buttons can function to select between choices displayed to the user on the electronic display 71. For example, one of the soft labels could display the text, “UP,” and when a user presses the corresponding button the visual highlight 99 moves to the choice above the current choice. Additionally, one soft label could display the text, “SELECT,” and when a user presses the corresponding button, the currently-highlighted choice is chosen.

FIG. 5 shows an example application of the electronic display 71. The electronic display shows a rest screen that displays by default when the master control unit is not informed of any events such as the existence of a new wall outlet device, or a problem at one of the wall outlets. The rest screen displays to the user, for example, three choices. A choice labeled “Setup,” when selected by the user, could lead to a screen that offers various general setup options such as the option to enter room labels. A choice labeled “Status and configuration of outlets” could lead to a screen (for example, FIG. 4) that displays the status of each wall outlet or transmitter box 13. A choice labeled “Connect a new outlet device” could lead to a screen (not shown) that merely informs the user that the control unit is ready to detect a new outlet device.

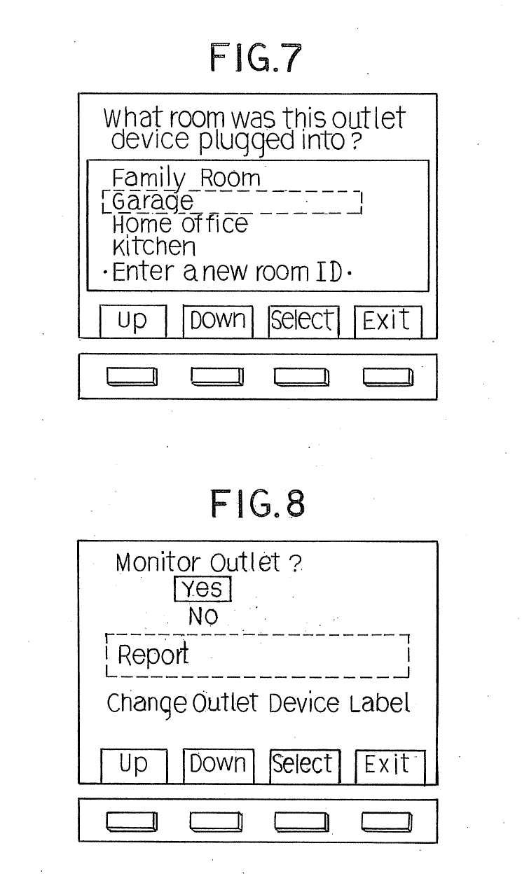

In one example, when a newly plugged-in transmitter box transmits initiation information to main control unit 17, electronic display 71 changes automatically to a screen (for example, FIG. 6) that informs the user that the control unit has detected a new outlet device and asks the user if the user would like to setup the device. The user may actuate one of the manually operable buttons to begin setup of the new transmitter device (or a box 13). Additionally, the electronic display may change to a setup screen (for example, FIG. 7) that allows the user to configure the new transmitter box. This setup screen may ask the user to select a location identifier or a room label for the new transmitter box. The user may select from among pre-entered room labels, or the user may choose to enter a new room label. For example, after a transmitter box 13 is plugged into an outlet in the kitchen, the user may next enter into main control unit 17 information that the identifier “kitchen” is associated with the unique number of the transmitter box 13. Other such identifiers could include: bath, living room, den, library, hallway, exercise room, bedroom 1, bedroom 2, bedroom 3, garage, etc.

In another example, in addition to identification of the room, the user may further associate more detailed location information with a transmitter box 13, such as the text, “west wall of kitchen.”

Alternatively, the main control unit may automatically receive the room label and other location information from the new transmitter box, in which case, the electronic display may merely confirm to the user the room label and other location information.

Referring to FIG. 4, display 71 displays, for example, four separate outlet indicia 73, 75, 77, 79, each visually representing one of four separate electrical wall outlets of the system. Indicia 73, 75 identify a unique number associated with a box 13, i.e., the number “1090” is associated with one box 13 and the number “1091” is associated with another box 13. The number associated with a box 13 may be transmitted to main control unit 17 by a box 13, for example, when box 13 is first plugged into an outlet 19, or at preset times. Indicia 77, 79 display an identification of the room location of a respective box 13. In order to display an identification of the room location of box 13, main control unit 17 may determine the room identity from information sent from box 13 or else entered into main control unit 17 by the user.

Adjacent each outlet indicia 73-79 is an indicator indicia 81, 83, 85, 87 on display 71. Each indicator indicia 81, 83, 85, 87 has a display active state and a display non-active state to show the user that a potential problem exists at the corresponding outlet identified by the respective outlet indicia 73, 75, 77, 79. The display active state indicates to the viewer that a high temperature has been sensed at the associated box 13. For example, the active state may be a flashing red rectangle.

Also shown on display 71 are two soft labels with words, respectively, UP and DOWN, which appear above corresponding manually operable buttons 91, 93 located on unit 17. A visual highlight 99 surrounds indicia 73, 81 and the highlight 99 is scrollable to move and surround a different one of indicias 75, 83, or 77, 85, or 79, 87, as up/down buttons 91, 93 are actuated by the user.

Also on display 71 is a soft label with the word SELECT, which appears above a manually operable button 95. Button 95 may be actuated in order to choose the currently-highlighted outlet indicia, thus causing the display to change to a screen (for example, FIG. 8) that presents the user with more options and information about the corresponding outlet. Other button arrangements will suggest itself, including button combinations, e.g., holding SELECT button 95 down while pushing UP and DOWN buttons 91, 93.

Also, on display 71 is a soft label with the word EXIT, which appears above a manually operable button 97. Button 97 may be actuated to exit from the screen being displayed and move to another display screen. Alternatively, button 97 may be used to turn OFF all alarms, if the fire condition has been cleared. Pressing button 97 will put the system into a silent mode.

Referring to FIG. 8, a screen 111 is displayed on display 71 for allowing the user to select whether an outlet is to be monitored by main control unit 17 or whether it is to be removed from being monitored by main control unit 17. For example, buttons may be operated to input entry of an activation or deactivation. In addition, buttons may be actuated to select “report,” and unit 17 may then provide a report of a selected outlet or all the outlets, showing for example, only the active outlets. The report may also reveal which outlet is problematic, and provide a diagnosis, e.g., electrical short, faulty wiring, loose wire cap, smoldering wire, etc. The report may be displayed on the electronic display 71 or else sent to a peripheral device. In addition, buttons may be actuated to select “change outlet device label.”Selecting this function could lead to a screen where the user can change the label identifier associated with the corresponding transmitter box.

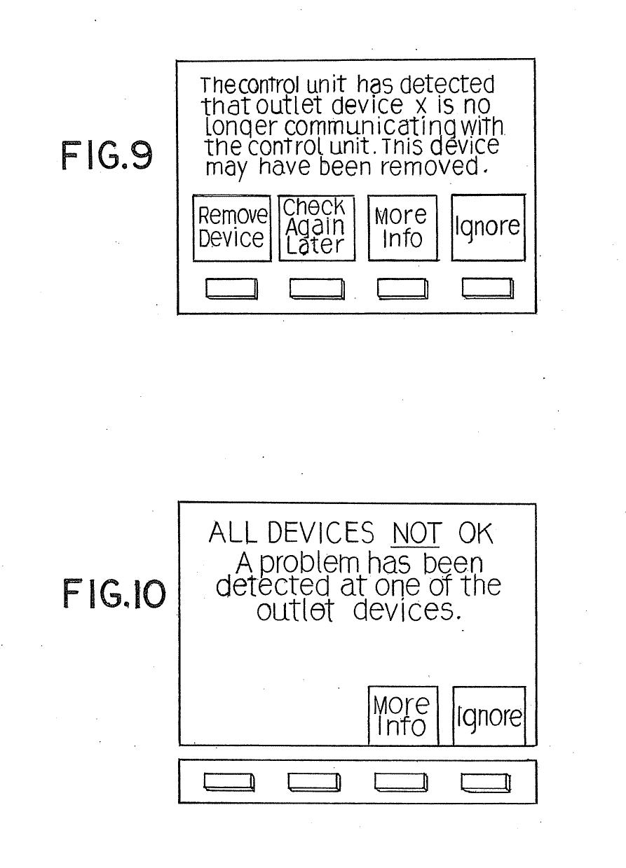

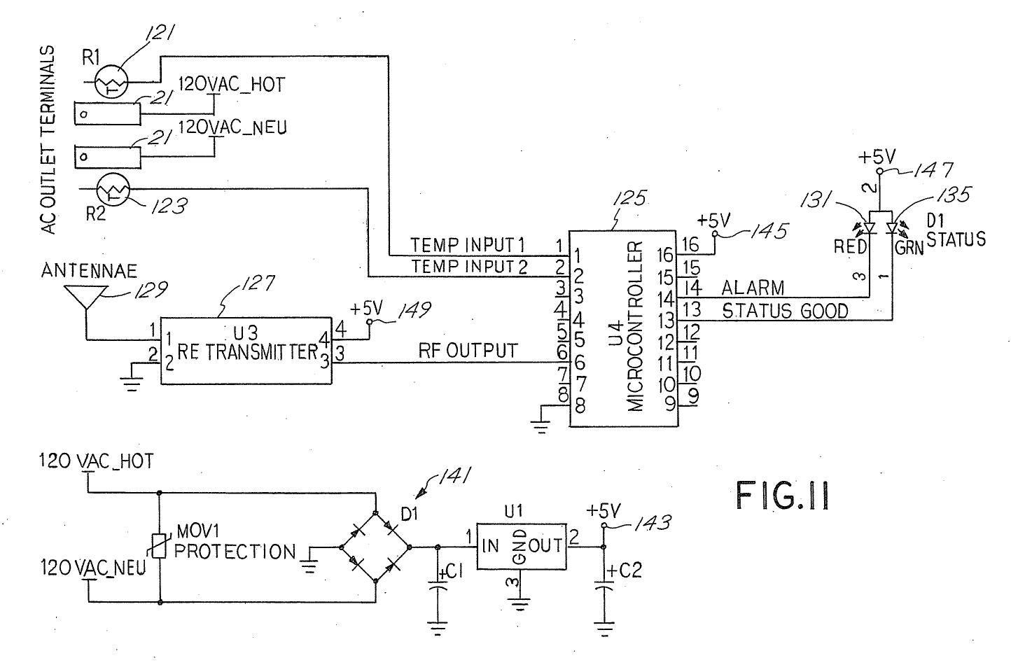

In another example, when a transmitter box 13 is removed from a wall outlet, the transmitter box sends a signal to the main control unit, or alternatively the main control unit detects the lack of a signal from the transmitter box. Additionally, the display 71 changes automatically to a screen (for example, FIG. 9) that informs the user that the control unit has detected that the transmitter box is no longer communicating with the control unit. Additionally, the user may use the manually operable buttons to select the action to take, such as removing the device from being monitored.

Also, when a problem exists at one of the transmitter boxes, the electronic display 71 may change to a screen that informs the user that a problem exists at one of the outlets. For example, when transmitter box 13 detects a problem at one of the outlets, it may send a signal to main control unit 17 indicating that a problem exists, such as high temperature, in transmitter box 13. In response, electronic display 71 at the main control unit may automatically change to a screen (for example, FIG. 10) that informs the user that all devices are not ok. The user may then actuate one of the manually operable buttons to see more information related to the alert, such as the identification of the transmitter box and details of the problem. Alternatively, the user may ignore the alert, in which case alerts related to specific outlets may be retrieved at a later time.

Additionally, transmitter box 13 may contain at least one LED on a side of the transmitter box. Each LED may inform the user of information related to the transmitter box. For example, one LED may glow green (or not glow) when transmitter box 13 is operating correctly and has detected no problems at the outlet. Also, this LED may glow red when transmitter box 13 has detected a problem. A separate LED may glow green (or not glow) when there are no active alarms outstanding for transmitter box 13. Also, this LED may glow red when an active alarm is outstanding for transmitter box 13. The user could, for example, choose to ignore the alarm at a particular transmitter box without fixing the problem. In this case, the transmitter box may display one LED that is glowing red, representing a problem at the outlet, and one LED that is glowing green (or not glowing), representing that no alarms are outstanding.

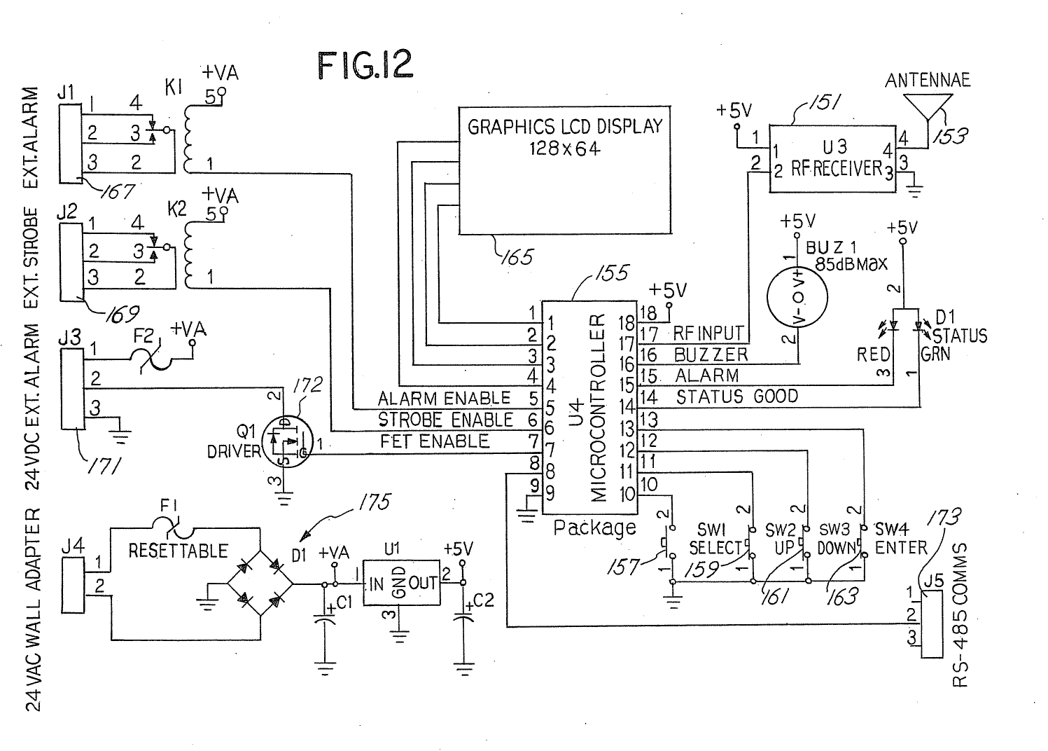

Referring to FIG. 11, metal prongs 21 may contact a conventional wall outlet and thus may reside at an equivalent voltage to the wall outlet. For example, the wall outlet could provide 120 volts, 240 volts, 380 volts, or other voltage configurations.

Metal prongs 21, located on the back side of box 13, are connected to receptacles 56 (not shown in FIG. 11, but shown in FIG. 3), located on the front side of box 13. Metal receptacles 56 provide an AC output voltage that is equivalent to the voltage of the wall outlet at prongs 21. For example, the receptacles could provide 120 volts, 240 volts, 380 volts, or other voltage configurations. Additionally, the connection between prongs 21 and receptacles 56 may run through a switch or thermistor (not shown in FIG. 11) that may limit or cut off current if a problem is detected.

Temperature sensors 121, 123 (e.g., thermistors) are positioned relative to metal prongs 21 for measuring the temperature at the prongs 21. The temperature signal from sensors 121, 123 is sent to a microcontroller 125 at its input pins 1, 2. Microcontroller 125 compares the temperature signals at input pins 1, 2 relative to a threshold value. If either of the temperature signals exceeds the threshold value, an output signal is developed at pin 6 of microcontroller 125. The output signal at pin 6 is sent to a RF transmitter circuit 127 for the purpose of causing a RF transmission to be made. Transmitter 127 may transmit at 455 KHz frequency, for example, so that the RF signal will not interfere with heart monitors and other wireless devices. Upon receipt of the output signal from microcontroller 125, transmitter circuit 127 transmits an RF signal from antennae 129.

The RF signal generated by transmitter circuit 27 is sent to main control unit 17. However, RF signal could be sent to a mobile device carried by a user. The RF signal includes coded data to communicate a danger signal to main control unit 17. Such coded data may also include the location of box 13 within the building. A room location may be uploaded by the user to memory in microcontroller 125. Thus, microcontroller 125 may identify the room location to transmitter circuit 127 for its transmission.

In addition, microcontroller 125 provides a pair of signals at pins 13, 14 to activate or deactivate either one of a red color LED 131 and a green colored LED 135. The light output of LEDs 131, 135 are used to provide a signal display at box 13 as to whether a potential fire condition has been sensed. Thus, LEDs 131, 135 may be positioned on the front face 25 of the transmitter box for viewing by the user.

In addition, a circuit 141 receives a voltage input from the metal prongs 21 when box 13 has been plugged-in to a wall outlet. Circuit 141 develops a 5 volt output at pin 143. The 5 volt output at pin 143 is used to power microcontroller 125 at pin 145, power the LEDs 131, 135 at pin 147, and power transmitter circuit 12 at pin 149.

Referring to FIG. 12, main control unit 17 includes an RF signal receiver 151 which receives an RF signal via a banana style antennae 153 mounted, for example, on the left side of unit 17. The output of receiver 151 is sent to a microcontroller 155. Microcontroller 155 analyzes the signal developed on its input pin 17. Information carried by the RF signal is a high temperature indication signal, and may include the identity of the box 13 which sent the RF signal. Microcontroller 155 may remain in a sleep mode so as to conserve power until a danger signal has occurred.

Microcontroller 155 receives input signals from one of four switches 157, 159 161, 163. Microcontroller 155 responds to input signals from four switches 157-163, which may be formed of a four-button membrane keypad, and accordingly actuates a graphics LCD display 165. Further, various alarms may be activated by microcontroller 155 sending signals to output ports 167, 169, 171. For example, a 85 decibel alarm may be activated when a danger signal occurs. Further, a field effect transistor driver 172 may be used to drive an external alarm. In addition, microcontroller 155 may communicate externally via an RE-485 port 173.

Finally, a power supply circuit 175 may generate 5 volts DC for driving the circuitry of FIG. 12. Circuit 175 may be powered by a 24 volt AC Wall adaptor. A full bridge rectifier reduces the 24 volts AC down to 6 volts. A voltage regulator (not shown) may be used to provide a constant 5 volt power supply. Further, a three volt Lithium battery (not shown) may be mounted on a main circuit board (not shown) of main control unit 17 so as to provide back up power if main power is lost. The back up power may be supplied to memory, e.g., RAM, so that data stored in control unity 17 is not lost.

As will suggest itself, the transmitter or transceiver of box 13 may be placed directly into the outlet housing, or in a light fixture or light switch or in a power strip. In a light switch application, a thermo-switch is connected in parallel to the circuitry of the light switch. A push-button may be used to reset the light switch.

While the detailed description of the invention generally relates to an alarm module containing a transmitter in the monitoring circuit, the description herein equally applies to an alarm module with a transceiver in the monitoring circuit.

While the invention has been particularly shown and described with reference to preferred embodiments thereof, it will be understood by those skilled in the art that various modifications in form and detail may be made therein without departing from the scope and spirit of the invention. Accordingly, modifications such as those suggested above, but not limited thereto are to be considered within the scope of the invention.

1. An early warning fire detection system comprising:
at least one portable, pluggable alarm module transmitter box having a front side and a back side each similar in shape to a conventional electrical wall outlet, and said alarm module transmitter box having circuitry, said circuitry comprising:
(1) a monitoring circuit for monitoring electrical wiring conditions; and
(2) a transmitter circuit for transmitting RF signals containing information developed by said monitoring circuit;
a main control unit that displays information received from said transmitter circuit of said alarm module transmitter box, said main control unit comprising:
a signal receiver in said main control unit that receives RF signals from said one alarm module transmitter box.

2. An early warning fire detection system of claim 1, further comprising:
a conventional three prong electrical plug located on the back side of said alarm module transmitter box to connect said alarm module transmitter box to a conventional electrical wall outlet; and
a conventional three prong electrical receptacle located on the front side of said alarm module transmitter box to receive conventional electrical plugs.

3. An early warning fire detection system of claim 2, wherein said circuitry includes:
a thermo switch that connects said three prong electrical plug to said three prong electrical receptacle, wherein said thermo switch opens in response to said circuitry detecting a problem.

4. An early warning fire detection system of claim 2, wherein said circuitry includes:
a thermistor that connects said three prong electrical plug to said three prong electrical receptacle, said thermistor having a resistance which increases as said circuitry detects increased temperature.

5. An early warning fire detection system of claim 1, wherein:
said circuitry is capable of detecting the problem of excessive current draw through electrical wiring; and
said transmitter circuit transmits RF signals containing information related to said excessive current draw.

6. An early warning fire detection system of claim 1, wherein:
said circuitry detects the problem of a short circuit; and
said transmitter circuit transmits RF signals containing information related to said short circuits.

7. An early warning fire detection system of claim 1, wherein:
said circuitry detects the problem of a temperature in excess of a threshold temperature; and
said transmitter circuit transmits RF signals containing information related to said excess temperature.

8. An early warning fire detection system of claim 1, wherein:
said transmitter circuit transmits RF signals containing unique information related to said alarm module transmitter box, said unique information including an identification number and a location;

9. An early warning fire detection system of claim 8, further comprising:
a plurality of alarm module transmitter boxes; and
an electronic display located on the main control unit to provide visual information about said plurality of said alarm module transmitter boxes;
one indicator indicia corresponding to one of said plurality of alarm module transmitter boxes, displayed on said electronic display, indicating whether said one transmitter box is active.

10. An early warning fire detection system of claim 9 and further including:
at least one manually operable button located on said main control unit to select and scroll through information on the electronic display.

11. A portable, pluggable alarm module transceiver box of an early warning fire detection system comprising:
a front side and a back side, each side being similar in shape to a conventional electrical wall outlet; and
circuitry, said circuitry comprising:
(1) a monitoring circuit for monitoring electrical wiring conditions; and
(2) a transceiver circuit adapted to transmit RF signals containing information developed by said monitoring circuit and adapted to receive RF signals;
A main control unit that displays information received from said transceiver circuit, said main control unit comprising; a signal receiver that receives RF signals from said transceiver box and a signal transmitter adapted to transmit RF signals.

12. An early warning fire detection system of claim 11, further comprising,
A plurality of transceiver boxes capable of communicating with each other to detect status of said transceiver boxes,
An electronic display located on the main control unit.

13. An early warning fire detection system of claim 11, further comprising:
a conventional three prong electrical plug located on the back side of said alarm module transceiver box to connect said alarm module transceiver box to a conventional electrical wall outlet; and
a conventional three prong electrical receptacle located on the front side of said alarm module transceiver box to receive conventional electrical plugs.

14. An early warning fire detection system of claim 11, wherein said monitoring circuit includes:
a first thermistor placed in close proximity to an electrical hot line of said three prong electrical plug;
a second thermistor placed in close proximity to a electrical neutral line of said three prong electrical; and
a third thermistor capable on monitoring ambient temperature.

15. A method for detecting and warning of potential fire conditions in electrical wiring by use of a transmitter box or a transceiver box pluggable into a wall electrical outlet, comprising:
detecting a problem in electrical wiring related to a wall electrical outlet by circuitry in said transmitter box or transceiver box monitoring the electrical wiring in close proximity to the wall electrical outlet;
generating an electrical signal in response to the detected problem;
transmitting said electrical signal in the form of an RF signal to a main control unit; and
displaying information on the main control unit about the status of at least one transmitter box.

16. A method according to claim 13, wherein:
said monitoring is directed to a problem of excessive current draw through the electrical wiring of the wall electrical outlet.

17. A method according to claim 13, wherein:
said monitoring is directed to a problem of a short circuit.

18. A method according to claim 13, wherein:
said monitoring is directed to a problem of excess temperature.

19. A method of claim 13, further comprising:
activating at least one alarm by sending signals from the main control unit, in response to a detected problem.

20. A method of claim 13, further comprising:
displaying an LED light in response to and indicating that said transmitter box has detected problem.
